(19) United States
(12) Patent Application Publication
(10) Pub. No.: US 2014/0010251 A1
(43) Pub. Date: Jan. 9, 2014

(54) Tunable Pumping Light Source for Optical Amplifiers

(71) Applicants: Nadhum Kadhum Zayer, Newton Abbot (GB); Jan Lewandowski, Torquay (GB); Ian Peter McClean, Brixham (GB)

(72) Inventors: Nadhum Kadhum Zayer, Newton Abbot (GB); Jan Lewandowski, Torquay (GB); Ian Peter McClean, Brixham (GB)

(73) Assignee: OCLARO TECHNOLOGY LIMITED, Northamptonshire (GB)

(21) Appl. No.: 13/978,705

(22) PCT Filed: Jan. 6, 2012
(86) PCT No.: PCT/GB2012/050021

§ 371 Date: Sep. 25, 2013

(30) Foreign Application Priority Data
Jan. 7, 2011 (GB) 1100225.0

(51) Int. Cl. H01S 3/10

(52) U.S. Cl. CPC H01S 3/10007
USPC 372/20; 359/334; 359/341.3; 359/333

(57) ABSTRACT

A tunable external cavity laser for use as a pump laser in an optical amplifier such as a Raman amplifier or erbium doped fibre amplifier comprising a semiconductor gain device (12) operable to provide light amplification, a diffraction grating (18) for selecting the wavelength of operation of the laser and a MEMs actuator for changing the selected wavelength. A plurality of gain devices can be coupled together to improve the bandwidth or gain of the optical amplifier.

### TECHNICAL FIELD

The present invention relates to a pumping light source for use in optical amplifiers, more particularly, but not exclusively, to a tunable pumping light source for use in erbium doped fibre amplifiers or Raman amplification.

### BACKGROUND ART

Optical transmission systems require amplification to compensate for or overcome optical losses such as transmission loss occurring in the optical fibre, connector loss, or component loss.

One method of amplification involves amplifying the optical signal directly, i.e. without applying an electrical signal to the amplifier.

Optical transmission systems require amplification to overcome optical losses such as fibre loss, connector loss or component loss. Several options exist for amplification including Erbium Doped Fibre Amplifiers (EDFA), Semiconductor Optical Amplifiers and Raman amplification. This disclosure provides a pump laser source that has significant benefit for Raman amplification. The component simplifies manufacture as only one variety is needed to fulfil the need of several different pump lasers as used in today's amplifier designs. For a Raman amplifier system this disclosure improves system integration and can provide improved system performance. For an EDFA this disclosure can be used to optimise performance depending on the final application.

A Raman amplifier system requires at least one pumping light source at a defined operating wavelength to achieve amplification and often more than one pumping light source of different wavelengths to achieve gain over a wider range of gain wavelength.

It is known to provide multiple pumping light sources wherein each of the light sources is “locked” to a predetermined wavelength Fibre Bragg Grating.

It is an object of the present invention to provide a tunable pumping light source for use in optically pumped optical amplifiers.

### SUMMARY

The present disclosure seeks to overcome or at least mitigate the problems of the prior art.

According to one aspect of the present invention there is provided a tunable light source for use in an optical amplifier. The tunable light source comprises a gain device, wavelength selector and output coupler. The gain device is operable to provide light amplification and comprises a gain medium and a first reflective surface. The wavelength selector is configured to select a part of the light from the gain device. The output coupler directs a portion of the selected part of the light from the gain device into an optical propagator for coupling to an optical amplifier, and another portion towards the wavelength selector. The gain device, output coupler and wavelength selector form a resonator. The output coupler may comprise a beam splitter.

The tunable light source may comprise two or more optical resonators each comprising a gain device forming part of a respective resonator wherein light output from each resonator is coupled together by a combiner and directed into the optical propagator.

Optionally, the tunable light source further comprises an actuator for changing wavelength of the selected part of the light from the gain device.

Optionally, the actuator rotates the wavelength selector about an axis perpendicular to the direction of travel of the light.

Optionally, the actuator rotates a light redirector, preferably a mirror, which light redirector directs light from the gain device on to the wavelength selector wherein the light redirector is rotated about an axis perpendicular to the direction of travel of the light.

Optionally, the actuator structurally deforms the wavelength selector to change the wavelength selected.

Optionally, the structural deformation includes stretching, compressing and or bending the wavelength selector. Preferably, the tunable light source further comprises an isolator for preventing feedback when the light source is used in an optical amplifier. Optionally, the output coupler is a beam splitter. Optionally, the output coupler is a reflective diffraction grating. Optionally, a light redirector directs light into the optical propagator.

In accordance with another aspect of the present invention there is provided a tunable light source for use in an optical amplifier. The light source comprises two or more gain devices operable to provide light amplification, each gain device comprising a gain medium and a first reflective surface. Two or more actuatable wavelength selectors are provided, each configured to select a part of the light from one of the gain devices. The source further comprises at least one output coupler. Each output coupler, wavelength selector and gain device form a resonator, wherein the output coupler directs a portion of the light from each gain device into an optical propagator for coupling to an optical amplifier.

In accordance with one embodiment there is provided a tunable light source for use in an optical amplifier comprising a gain device operable to provide light amplification, the gain device comprising a gain medium and a first and second end the first end forming an end of an optical resonator, a lens for collimating radiation emitted from the second end of the gain device and directing the radiation onto a beam splitter acting as an output coupler for allowing a portion of radiation to escape the optical resonator and for retaining a remaining portion within the optical resonator, a reflective diffraction grating for wavelength selection of the radiation and forming a second end of the optical resonator, and an actuator coupled to the reflective diffraction grating and operable to change the wavelength selection.

Optionally, the tunable light source comprises a second gain device operable to provide light amplification the gain device comprising a second gain medium and a first and second end the first end forming an end of an second optical resonator, a second lens for collimating radiation emitted from the second end of the second gain device and directing the radiation onto a second beam splitter acting as a second output coupler for allowing a portion of radiation to escape the second optical resonator and for retaining a remaining portion within the second optical resonator, a second reflective diffraction grating for wavelength selection of the radiation and forming a second end of the second optical resonator, and a second actuator coupled to the second reflective diffraction grating and operable to change the wavelength selection of the second optical resonator.

Optionally, the tunable light source comprises a combiner for combining the radiation from the first and second optical resonators.

Optionally, a lens directs light into an optical fibre.

Optionally, the tunable light source further comprises an isolator for preventing feedback when the light source is used in an optical amplifier. Optionally, the first and second beam splitters are offset from one another to prevent coupling radiation from one of the first or second optical resonators into the other of the first or second optical resonators.

Optionally, the first and second beam splitters reflect the retained portion of the radiation in different directions, optionally opposite directions. Optionally, the first and second beam splitters reflect the retained portion of the radiation in the same direction.

Optionally, the or each beam splitter reflects the retained portion of the radiation in each of the first and second optical resonators onto a light redirector, such as a mirror, which light redirector directs the radiation on to the or each reflective diffraction grating and wherein the or each actuator is coupled to the or each light redirector.

Optionally, the first beam splitter reflects the respective retained portion of the radiation onto a first light redirector, such as a mirror, which first light redirector directs the radiation in the first optical resonator onto the first reflective diffraction grating and wherein the second beam splitter reflects the respective retained portion of the radiation onto a second light redirector, such as a mirror, which second light redirector directs the radiation in the second optical resonator onto the second reflective diffraction grating and wherein the first and second actuators are coupled to the first or second light redirectors respectively.

Optionally, the first beam splitter reflects the respective retained portion of the radiation onto a first light redirector, such as a mirror, which first light redirector directs the radiation in the first optical resonator onto the reflective diffraction grating and wherein the second beam splitter reflects the respective retained portion of the radiation onto a second light redirector, such as a mirror, which second light redirector directs the radiation in the second optical resonator onto the reflective diffraction grating such that the reflective diffraction grating forms part of both the first and second optical resonators and wherein the first and second actuators are coupled to the first or second light redirectors respectively.

According to another embodiment there is provided a tunable light source for use in an optical amplifier comprising a gain device operable to provide light amplification the gain device comprising again medium and a first and second end the first end forming an end of an optical resonator, a lens for collimating radiation emitted from the second end of the gain device and directing the radiation onto a reflective diffraction grating for wavelength selection of the radiation and acting as an output coupler allowing a portion of radiation to escape the optical resonator and retaining a remaining portion within the optical resonator, a light redirector, such as a mirror, forming a second end of the optical resonator and an actuator coupled to the light redirector and operable to change the wavelength selection. The tunable light source comprises a second gain device operable to provide light amplification; the gain device comprising a second gain medium and a first and second end the first end forming an end of a second optical resonator, a second lens for collimating radiation emitted from the second end of the second gain device and directing the radiation onto a second reflective diffraction grating for wavelength selection of the radiation and acting as a second output coupler for allowing a portion of radiation to escape the second optical resonator and for retaining a remaining portion within the second optical resonator, a second light redirector, such as a mirror, forming a second end of the second optical resonator and a second actuator coupled to the second light redirector and operable to change the wavelength selection of the second optical resonator wherein the reflective diffraction grating forms part of both the first and second optical resonators.

Optionally, the tunable light source comprises a combiner for combining the radiation from the first and second optical resonators.

Optionally, the actuator comprises a Microelectromechanical system (MEMS).

Optionally, the two or more optical resonators provide light at different wavelengths, although in some embodiments they may provide light at the same wavelength.

According to one embodiment there is provided an optical amplifier comprising a tunable light source as hereinbefore described.

According to another embodiment there is provided a Raman amplifier system for amplification of an optical signal comprising utilising at least one tunable light source, hereinbefore described, as a pump light source.

Optionally, the Raman amplifier system comprises two or more tunable light sources which are combined to increase the gain, or amplification of the optical signal, of the amplifier system.

Optionally, the Raman amplifier system comprises two or more tunable lights sources which are combined to increase the bandwidth over which the optical signal can be amplified.

According to another embodiment there is provided an erbium doped fibre amplifier system for amplification of an optical signal comprising utilising the tunable light source as herein before described as a pump light source for excitation of erbium atoms in an optical fibre.

### BRIEF DESCRIPTION OF THE DRAWINGS

Exemplary embodiments will now be described with reference to the accompanying drawings, in which:

FIG. 1A illustrates a schematic view of a tunable light source;

FIG. 1B illustrates a schematic view of the spectral output, intensity against wavelength, of the semi-conductor gain device illustrated in FIG. 1A;

FIG. 1C illustrates the spectral input, intensity against wavelength, into the optical transmission fibre illustrated in FIG. 1A at different angular positions of the wavelength selector;

FIG. 2A illustrates a schematic view of an alternative tunable light source;

FIG. 2B illustrates a schematic view of the spectral output, intensity against wavelength, of each of the semiconductor such devices of FIG. 2A;

FIG. 2C illustrates the spectral input, intensity against wavelength, into the optical transmission fibre illustrated in FIG. 2A;

FIG. 3A illustrates a schematic view of a further alternative tunable light source;

FIG. 3B illustrates a schematic view of the spectral output, intensity against wavelength, of each of the semiconductor gain devices of FIG. 3A;

FIG. 3C illustrates a schematic view of the spectral input, intensity against wavelength, into the optical transmission fibre illustrated in FIG. 3A;

FIG. 4A illustrates a schematic view of another tunable light source;

FIG. 4B illustrates a schematic view of the spectral output, intensity against wavelength, of each of the semiconductor gain devices of FIG. 4A;

FIG. 4C illustrates a schematic view of the spectral input, intensity against wavelength, into the optical transmission fibre illustrated in FIG. 4A;

FIG. 5A illustrates a schematic view of another tunable light source;

FIG. 5B illustrates a schematic view of the spectral output, intensity against wavelength, of each of the semiconductor gain devices of FIG. 5A;

FIG. 5C illustrates a schematic view of the spectral input, intensity against wavelength, into the optical transmission fibre illustrated in FIG. 5A;

FIG. 6A illustrates a schematic view of another tunable light source;

FIG. 6B illustrates a schematic view of the spectral output, intensity against wavelength, of each of the semiconductor gain devices of FIG. 6A;

FIG. 6C illustrates a schematic view of the spectral input, intensity against wavelength, into the optical transmission fibre illustrated in FIG. 6A;

FIG. 7 illustrates another tunable light source;

FIG. 8 is a schematic view of an optical amplifier including the tunable light source of any of FIG. 1A to 7; and

FIG. 9 is a schematic view of the gain spectrum of the optical amplifier of FIG. 8 comprising four tunable light sources having four different peak wavelengths.

### DETAILED DESCRIPTION OF EXEMPLARY EMBODIMENTS

Detailed descriptions of specific embodiments of the package, blanks and cartons are disclosed. It will be understood that the disclosed embodiments are merely examples of the way in which certain aspects of the disclosure can be implemented and do not represent an exhaustive list of all of the ways the disclosure may be embodied. Indeed, it will be understood the tunable light source described herein may be embodied in various and alternative forms. The Figures are not necessarily to scale and some features may be exaggerated or minimised to show details of particular components. Well-known components, material or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the disclosure.

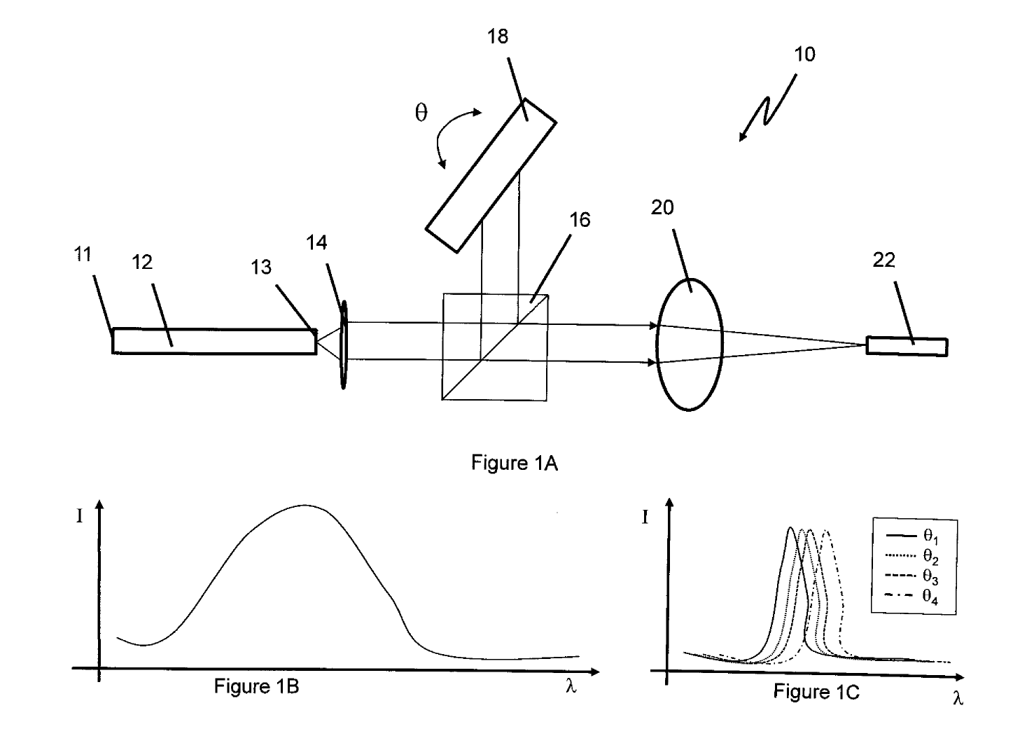

Referring to FIG. 1A there is shown a schematic view of a tunable light source 10 which comprises an optical resonator also known as an “optical cavity”.

The light source 10 comprises a semi-conductor gain device 12 optionally a direct band gap semi-conductor, such as but not limited to gallium arsenide, aluminium gallium arsenide, gallium phosphide, indium gallium phosphide, gallium nitride, indium gallium arsenide, indium gallium arsenide nitride, indium phosphide, gallium indium phosphide, indium gallium arsenide phosphide.

The choice of material will depend upon the wavelength at which it is desired to operate. In some embodiments, for example those intended to pump erbium doped fibre, the desired wavelength will be in the near infra red spectral region around 700 nm to about 1500 nm, more preferably around 970 nm to around 1000 nm for example 980 nm, or preferably around 1460 nm to 1500 nm, for example 1480 nm. Alternative embodiments, for example where the pump has to be used for the wavelength Raman amplification, will be in the short wavelength infra red spectral region, 1-4 μm, more preferably in the range of 1400 nm to 1500 nm, more preferably, the pump wavelength is around 1455 nm so as to optimise amplification in the C-band around 1530-1565 nm range; since in silica based optical fibres the maximum gain is obtained for a frequency offset of around 10 to 15 THZ for example 13.2 THZ (equivalent to around a 100 nm wavelength shift).

It is envisaged that the gain device 12 will be formed from a diode having a p-n junction which emits light in response to stimulation by an electrical current. The gain device 12 will be provided with electrical contacts for supplying the electrical current thereto. A first face 11 of the gain device 12 is arranged to be a highly reflective surface, preferably this may be achieved by cleaving the material from which the gain device 12 is constructed to form a smooth surface; in an alternative embodiment a reflective coating may be applied.

Radiation is emitted from a second face 13 in a divergent beam. This divergent beam of radiation is collimated by a lens 14. The collimated radiation is then directed onto a beam splitter 16; a first portion of the incident radiation beam passes through the beam splitter 16 and, is transmitted by the beam splitter 16. A second portion of the incident radiation beam is reflected in a direction substantially perpendicular to the incident radiation beam. The radiation is “tapped out” using the beam splitter 16 which acts as an output coupler; the output power efficiency and/or the laser threshold level are determined by the transmission/reflection ratio at the beam splitter 16.

The reflected portion is directed onto a wavelength selector 18. In one embodiment the wavelength selector is a reflective diffraction grating. Optionally the diffraction grating is “blazed” to improve the efficiency; this also improves the wavelength selectivity of the resonator. The wavelength selector 18 is mounted on a moveable platform. The platform may be rotated so as to adjust the angle at which the radiation is incident upon the grating. It is envisaged that the wavelength selector 18 would be mounted upon an actuator for example a MEMS micro-actuator; wherein said micro-actuator may be coupled to a control system.

The wavelength selector 18 diffracts at least a portion of the incident radiation beam back along the same path as the incident beam i.e. anti-parallel to the incident radiation beam. The wavelength selector 18 only diffracts a narrow bandwidth of the radiation spectrum incident upon it.

The wavelength of the diffracted radiation beam is adjustable by rotating the wavelength selector 18 so as to change the angle at which the radiation is incident upon the wavelength selector 18.

Together the reflective surface 11, the wavelength selector 18 and the beam splitter 16 form a resonator, thus forming an external cavity diode laser.

An optional optical retarding device may be positioned between the collimating lens 14 and the beam splitter 16 or between the wavelength selector 18 and the beam splitter 16.

The portion of the radiation beam transmitted through the beam splitter 16 is focussed by a lens 20 onto the end of an optical transmission fibre, preferably the lens 20 is arranged to collect the radiation beam transmitted through the beam splitter 16 and focus the radiation beam to be within the acceptance cone of the optical transmission fibre. The optical transmission fibre can be used to propagate the portion of the radiation beam transmitted through the beam splitter 16.

FIG. 1B illustrates the output spectrum of the gain device 12 comprising a gain medium. It can be seen that the gain device has a broad bandwidth when compared to the output spectrum of the resonator formed from the reflective surface 11 of the gain device 12, the wavelength selector 18 and the beam splitter 16, as illustrated in FIG. 10.

FIG. 1C illustrates the spectrum of the resonator for four different angles θ₁, θ₂, θ₃, θ₄ of orientation of the wavelength selector 18; the peak intensity of the spectrum occurs at four different wavelengths.

Radiation incident upon the wavelength selector 18 is diffracted by the wavelength selector 18. The radiation is dispersed, that is to say, separated by its wavelength. The angle at which the radiation is diffracted is dependent upon its wavelength. This diffraction allows the wavelength of the resonator to be selected or adjusted. The wavelength of the resonator can be ‘tuned’ for the optimum performance of the system. In embodiments using a diffraction grating as the wavelength selector 18 the angle at which the radiation is diffracted is also dependent upon the grating pitch, the spacing between the slits or grooves of the grating. Wavelength selection can therefore be achieved by changing the grating pitch. This can be achieved by structural deformation of the grating for example stretching or compressing the grating, the same effect could be achieved by bending the grating convexly or concavely with respect to the incident radiation. It is envisaged that the micro-actuators or MEMS could be employed to achieve the structural deformation of the wavelength selector 18.

In this way only a selected narrow band of wavelengths is directed back into the gain device 12, such that the resonator produces a narrow bandwidth of radiation which is selected by the angle the wavelength selector is disposed relative to the reflected beam. In alternative embodiments the wavelength selector 18 may use deformation of the grating to vary the narrow band of wavelengths directed back into the gain device 12.

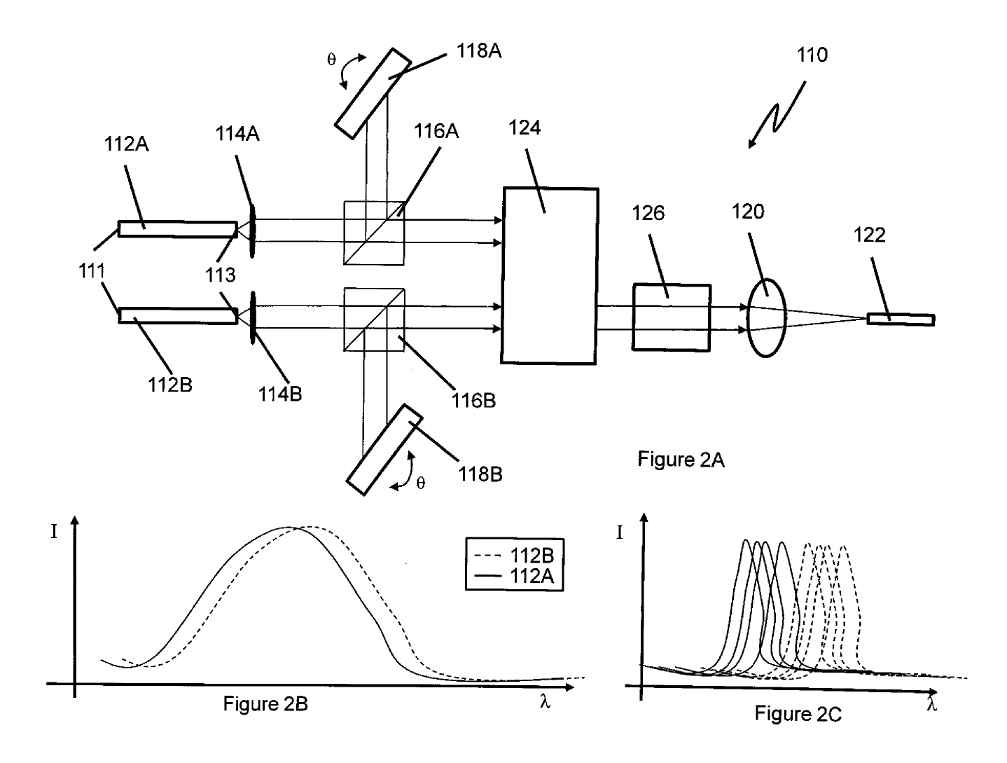

FIGS. 2A to 7 illustrate alternative tunable light sources. In the second and subsequent illustrated examples, like numerals have, where possible, been used to denote like parts, albeit with the addition of the prefix “100” or “200” and so on to indicate that these features belong to the second or subsequent examples. The alternative embodiments share many common features with the first embodiment and therefore only the differences from the embodiment illustrated in FIG. 1A will be described in any greater detail.

FIG. 2A illustrates a tunable light source which comprises a pair of gain devices 112A, 112B; the output radiation from each gain device 112A, 128B is collimated by a respective collimating lens 114A, 114B.

The collimated beam from first lens 114A is directed to a first beam splitter 116A, and the collimated beam from the second lens 114B is directed to a second beam splitter 116B.

The beam splitters 116A, 1168 are arranged to reflect a portion of the respective incident beams in opposite directions. In an alternative embodiment it will be appreciated that the beams may be reflected in different directions.

The reflected portion of the beam from beam splitter 116A is directed onto a first wavelength selector 118A, as the reflected portion of the beam from beam splitter 116B is directed onto a second wavelength selector 118B.

Each of the wavelength selectors 118A, 118B is mounted upon an actuator to allow independent rotation of each of the wavelength selectors 118A, 118B with respect to each other; this allows the diffracted wavelength of each resonator to be selected separately.

The reflective surface 111A of gain device 112A, the reflective surface of the beam splitter 116A and the reflective surface of the wavelength selector 118A form a first resonator.

The reflective surface 111B of the gain device 112B, the reflective surface of the beam splitter 116B and the reflective surface of the wavelength selector 118B form a second resonator.

The outputs of each resonator are combined together by a beam combiner 124. The beam combiner 124 is preferably a polarisation beam combiner. In alternative embodiments the beam combiner 124 may utilise spatial or wavelength combination.

The combined radiation from the beam combiner 124 then passes though an isolator 126, this prevents, or reduces, feedback of radiation and isolates the pump light source from an optical amplifier system to which it is coupled.

A focusing lens 120 redirects the radiation so that it can be captured in an optical transmission fibre 122.

In an alternative embodiment, not illustrated, the first beam splitter 116A and the second beam splitter are offset from one another; they are disposed at different distances from the respective collimating lens 114A, 114B. This prevents cross-coupling between the two resonators, any portion of the diffracted radiation from the first wavelength selector 118A of the first resonator which is transmitted through the first beam splitter 116A cannot be coupled into the second resonator by the second beam splitter 116B; the offset also prevents cross-coupling of radiation diffracted from the second wavelength selector into the first resonator by the first beam splitter 116A.

In yet a further embodiment the cross-coupling could be prevented by placing a filter between the first beam splitter 116A and the second beam splitter 116B.

FIG. 2B illustrates the output spectrum of each of the gain devices 112A, 112B, the output spectrum of each gain device may not be identical; the output spectrum of each gain device has a broad bandwidth up to around 10 nm.

FIG. 2C illustrates the spectrum input into the optical transmission fibre 122. The spectrum comprises two distinct peaks, provided by each of the resonators, at different wavelengths each having a narrow band width, wherein the peak wavelength of each peak can be adjusted.

It is envisaged that the spectral output from each resonator may be tuned individually so that the peak wavelength from each resonator coincides at substantially the same wavelength thereby increasing the intensity of radiation at a given wavelength which is input into the optical transmission fibre.

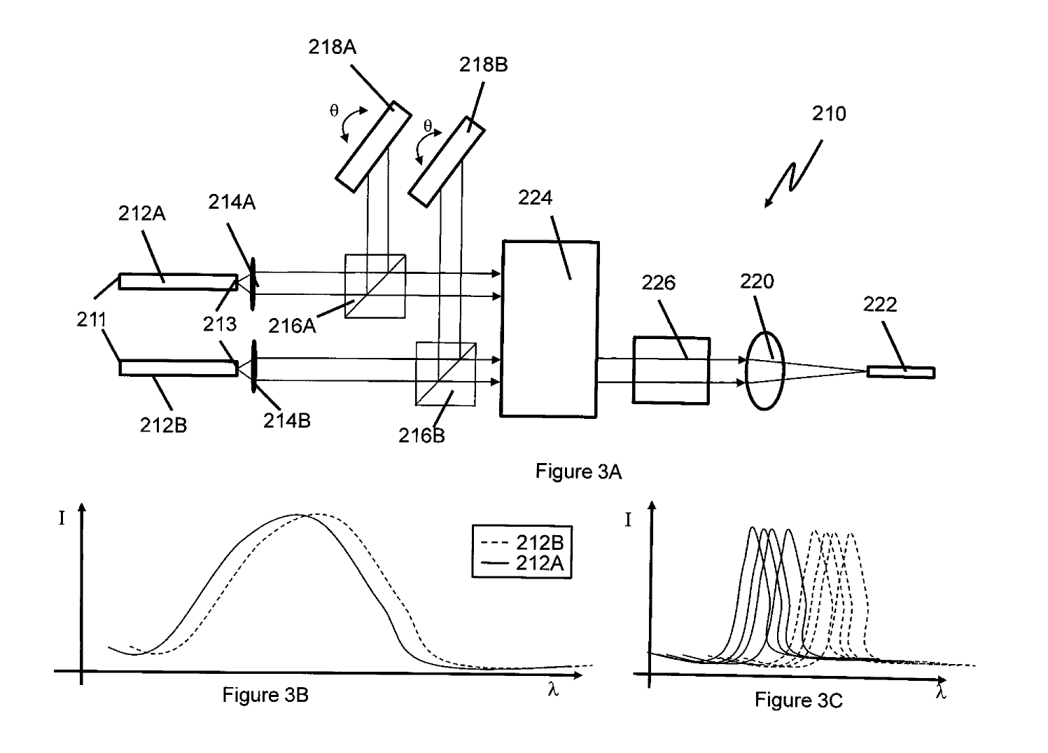

FIG. 3A illustrates an alternative configuration for coupling two resonators together. In this embodiment the beam splitters 216A, 216B are arranged so as to redirect the reflected beam in the same direction, as a pair of parallel beams. The beam splitter 261B is disposed a greater distance from the collimating lens 214B than distance the beam splitter 216A is disposed from the collimating lens 214B.

FIG. 3B illustrates the output spectrum of each of the gain devices 212A, 212B, the output spectrum of each gain device may not be identical; the output spectrum of each gain device has a broad bandwidth up to around 10 nm.

FIG. 3C illustrates the spectrum input into the optical transmission fibre 222. The spectrum comprises two distinct peaks at different wavelengths each having a narrow bandwidth, the peak wavelength of each peak can be adjusted.

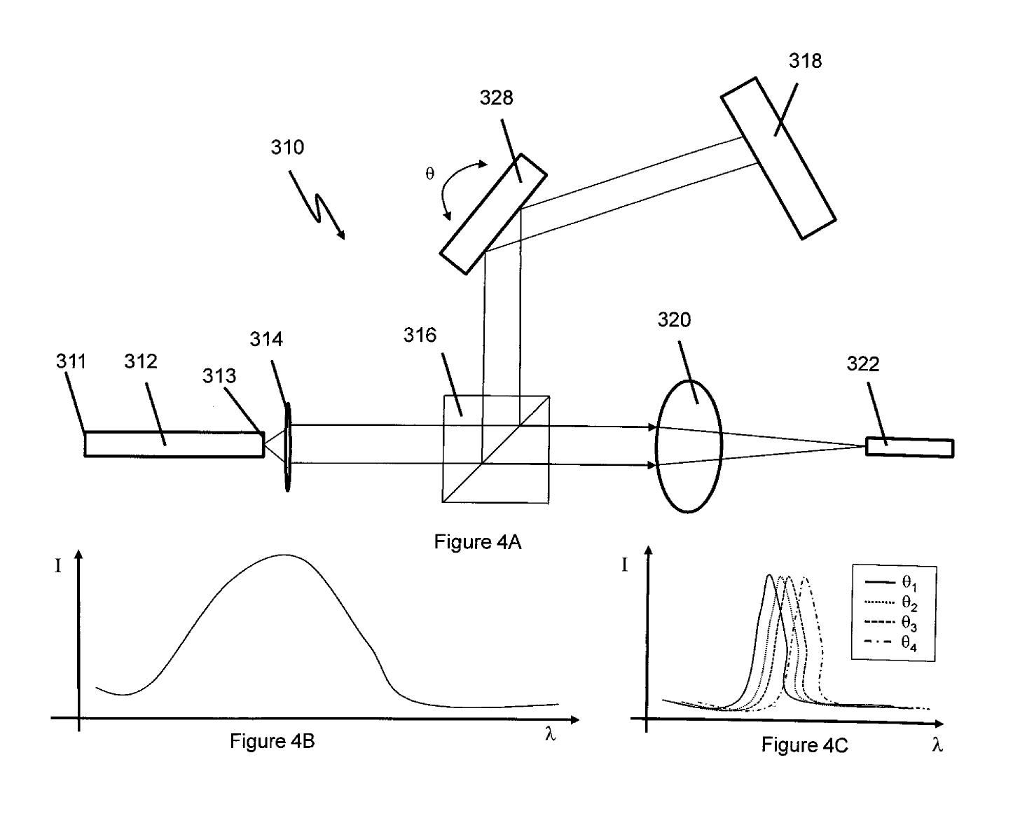

FIG. 4A illustrates a tunable light source in which the radiation beam reflected from the beam splitter 316 is directed onto a mirror 328. Mirror 328 is mounted on a moveable chassis such that the mirror 328 can be rotated about an axis perpendicular to the direction of travel of the radiation. Again it is envisaged that micro-actuators or MEMS may be used to achieve the rotation of the mirror 328.

An advantage of this arrangement is simpler manufacturability and lower cost. Combining the features of wavelength selectivity, provided by the wavelength selector 18, and tunability provided by the micro-actuator or MEMS in one component as illustrated in FIGS. 1A, 2A and 3A requires narrower manufacturing tolerances which increases the components specification requirements and cost.

A further advantage of using a separate scanning MEMS mirrors and bulk optic gratings are that they relatively simple to manufacture.

The mirror 328 directs the radiation onto a wavelength selector 318. The wavelength selector 318 is mounted in a fixed orientation.

Wavelength selector 318 is again envisaged to be a reflective diffraction grating which is arranged such that the diffracted radiation is anti-parallel to the incident radiation. i.e. reflected back along in the direction from whence it came.

FIG. 4B illustrates the output spectrum of the gain device 312 comprising the gain medium. It can be seen that the gain device 312 has a broad bandwidth when compared to the output spectrum of the resonator formed from the reflective surface 311 of the gain device 312, the wavelength selector 318 and the beam splitter 316 and the mirror 328, as illustrated in FIG. 4C.

FIG. 4C illustrates the spectrum of the resonator for four different angles θ₁, θ₂, θ₃, θ₄ of orientation of the mirror 328; the peak intensity of the spectrum occurs at four different wavelengths.

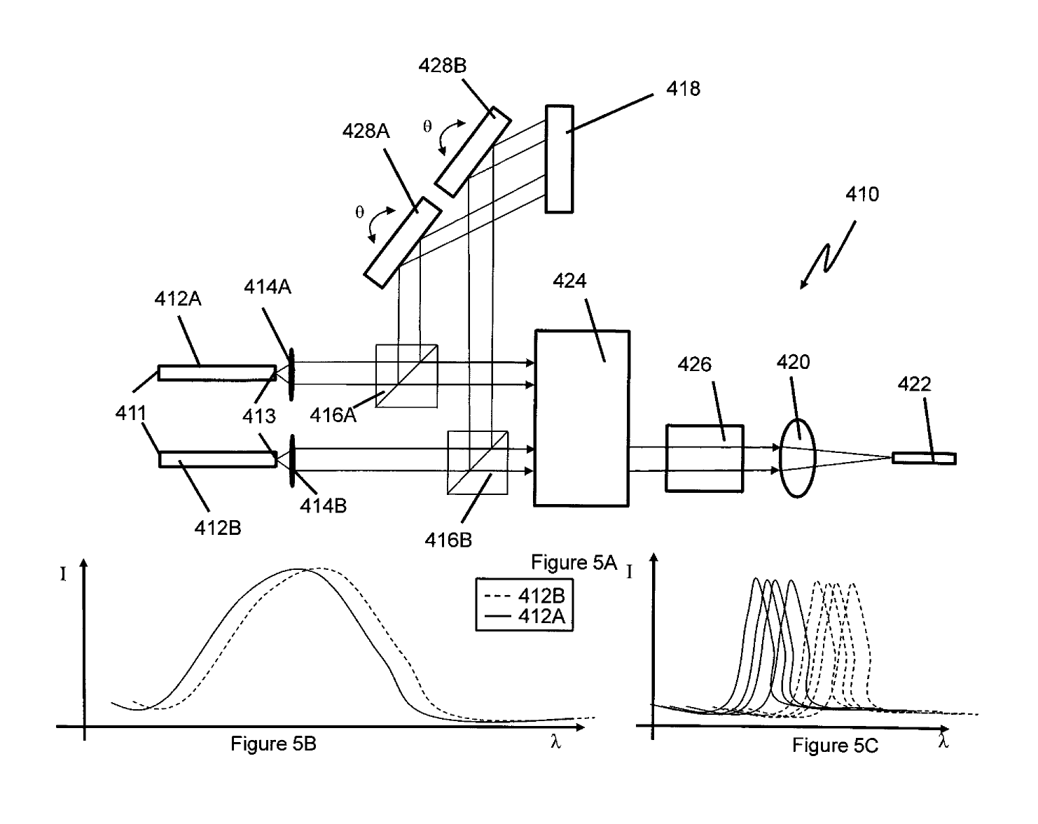

FIG. 5A illustrates a tunable light source in which a single wavelength selector 418 forms a part of each of a pair of resonators.

A first gain device 412A generates radiation which is collimated by a lens 414A and directed onto a first beam splitter 416A such that a portion of the collimated beam incident on the first beam splitter 416A is transmitted and a second portion of the collimated beam is reflected. The reflected portion is directed onto a first mirror 428A. The transmitted portion is directed onto a beam combiner 424.

The first mirror 428A directs the reflected beam onto a portion of the wavelength selector.

A second gain device 4128 generates radiation which is collimated by a second lens 414B. The second collimated beam is directed onto a second beam splitter 416B and again a portion of the collimated beam is transmitted and a second portion is reflected. The reflected portion is directed onto a second mirror 428B. The transmitted portion is directed onto the beam combiner 424.

The second mirror 428B directs the second reflected beam onto the wavelength selector 418.

The wavelength selector 418 diffracts a selected wavelength of each beam incident upon it, anti-parallel to the incident beams back onto the respective first or second mirror 428A, 428B, which in turn direct the selected wavelength back into the respective first or second gain device 412A, 412B via the respective first or second beam splitter 416A, 416B.

The first and second mirrors 428A, 428B are individually controllable so that they have to be rotated about an axis perpendicular to the radiation beams, in order to select the wavelength which is reflected back into the respective gain device 412A, 412B.

An advantage of using separate scanning MEMS mirrors and bulk optic gratings which are relatively simple to realise existing components when employing multiple resonators for multiple laser sources is reduced cost and greater simplicity. Multiple MEMS mirror components can be used to tune individual beams using a common bulk optic-defined grating, typically the more expensive component.

FIG. 5B illustrates the output spectrum of each of the gain devices 412A, 4128. The output spectrum of each gain device may not be identical; the output spectrum of each gain device has a broad bandwidth up to around 10 nm.

FIG. 5C illustrates the spectrum input into the optical transmission fibre 422. The spectrum comprises two distinct peaks at different wavelengths each having a narrow bandwidth, the peak wavelength of each peak can be adjusted by rotation of the mirrors 428A, 428B.

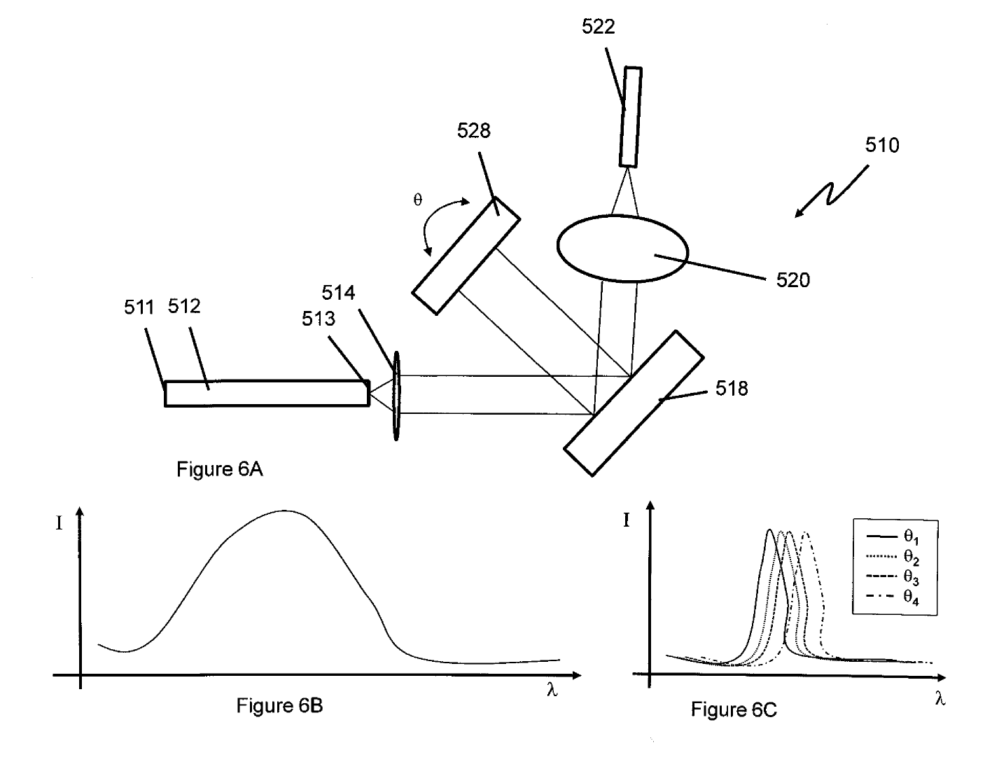

FIG. 6A illustrates a tunable wavelength source in which the lens 514 collimates the radiation from the gain device 512 and directs the collimated beam onto a fixed reflective diffraction grating 518. The first order diffracted beam is reflected back onto the diffraction grating 518 by a mirror 528. The wavelength can be tuned by rotating the mirror 528. This configuration may exhibit a smaller bandwidth than the previously described arrangements because the wavelength selectivity is stronger; the wavelength-dependent diffraction occurs twice instead of once per resonator round trip. The output power may be lower because the zero-order diffraction from the grating 518 of the beam reflected by the mirror 528 is not retained in the resonator. The resonator is formed from the reflective surface of the mirror 528, the grating 518 and the rear reflective surface 511 of the gain device 512. The grating 518 reflects a zero-order radiation beam onto lens 520. Lens 520 focuses the radiation it collects such that it can be captured in an optical transmission fibre 522. The grating 518 acts as the output coupler in this arrangement, removing the requirement for the beam splitter.

FIG. 6B illustrates the output spectrum of the gain device 512 comprising a gain medium. It can be seen that the gain device has abroad bandwidth when compared to the output spectrum of the resonator formed from the reflective surface of the mirror 528, the grating 518 and the rear reflective surface 511 of the gain device 512, as illustrated in FIG. 6C.

FIG. 6C illustrates the spectrum of the resonator for four different angles θ₁, θ₂, θ₃, θ₄ of orientation of the wavelength selector 518; the peak intensity of the spectrum occurs at four different wavelengths.

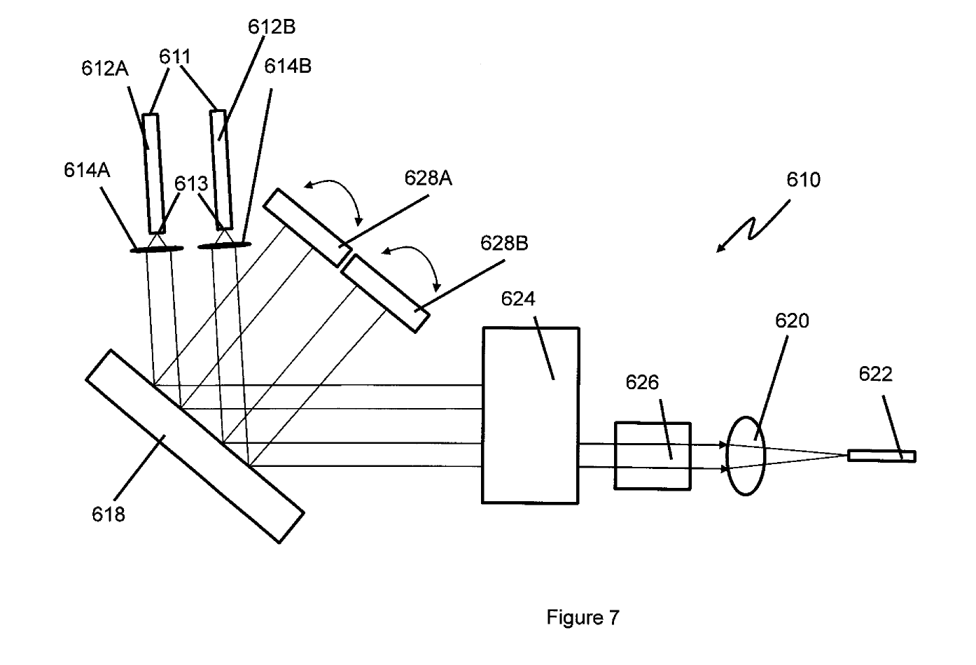

FIG. 7 illustrates a tunable light source in which a pair of gain devices 612A, 612B produce radiation which is collimated by first and second lenses 614A, 614B, respectively. Each collimated beam is directed onto a single wavelength selector 618. Preferably, the wavelength selector 618 is a reflective diffraction grating. The first order diffracted beam of each collimated beam is directed onto a respective mirror 628A, 628B; each mirror 628A, 628B reflects a selected bandwidth of the diffracted beam back towards the wavelength selector 618. The wavelength selector 618 diffracts each reflected beam back into the respective gain device 612A, 612B via the respective lens 614A, 614B. The zero-order diffracted beam from each gain device 612A, 6128 is directed into a beam combiner 624.

The outputs of each resonator are combined together in a beam combiner 624. The beam combiner 624 is preferably a polarisation beam combiner.

The combined radiation from the beam combiner 624 then passes though an isolator 626, this prevents, or reduces, feedback of radiation and isolates the pump light source from an optical amplifier system to which it is coupled.

A focusing lens 620 redirects the radiation so that it can be captured in an optical transmission fibre 622.

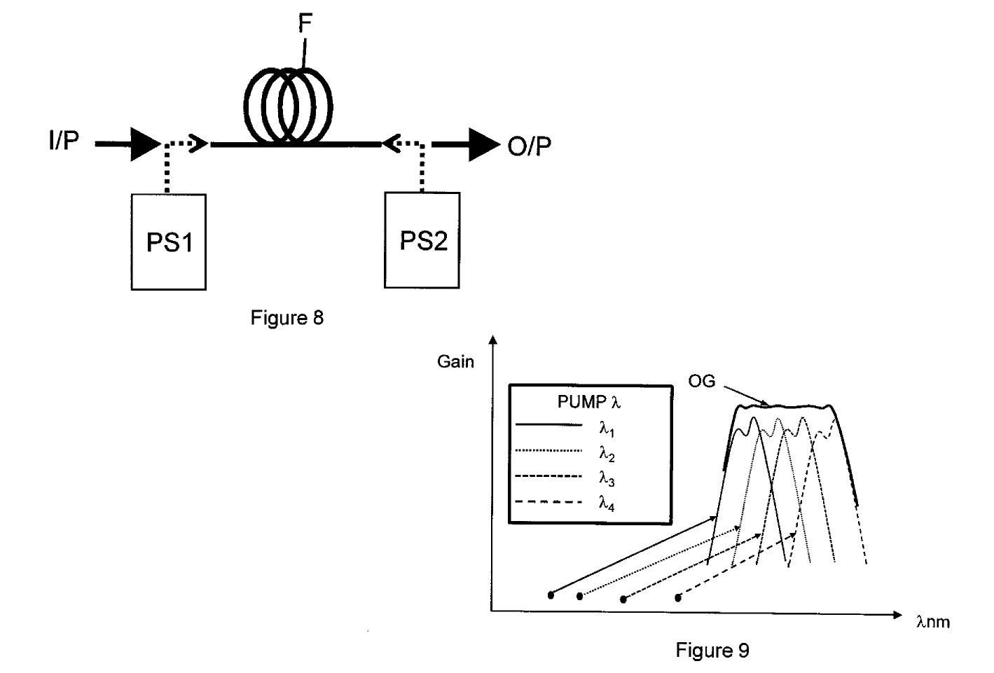

It is envisaged that the foregoing light sources 10, 110, 210, 310, 410, 510, 610 could be employed a pump light sources for an optical amplifier, FIG. 8 illustrates a schematic view of an amplifier system. The optical amplifier illustrated employs Stimulated Raman Scattering. Raman Scattering is a non-linear effect whereby high energy pump radiation incident on a medium is converted to a different frequency. Molecular vibrations create a modified lower energy level to which an excited molecule decays whilst simultaneously emitting a photon. The frequency shift is determined by the molecular vibrations of the material. This emission can be stimulated if a signal photon is present in the optical fibre with the pump radiation; this is known as Stimulated Raman Scattering (SRS). The decay may cause frequency shift to a lower frequency (Stokes shift) or to a higher frequency (anti-Stokes shift): typically Stokes shift is used to provide optical gain in telecommunications applications. The optical amplifier system illustrated in FIG. 8 comprises an optical fibre F into which an input optical signal I/P is coupled in a forward direction. The pump radiation may be coupled into the optical fibre at the input end in the forward direction “co-pumped” or at the output end in the reverse direction “counter pumped”. An amplified version of the input optical signal, the output optical signal O/P, is received at the output end of the optical fibre.

A single pump light source 10, 110, 210, 310, 410, 510, 610 operating at a single peak wavelength, and having a bandwidth of between about 1-3 nm, can provide sufficient optical gain over a finite bandwidth. In order to achieve optical amplification over broader bandwidths two or more pump light sources can be used, each having a different peak wavelength. FIG. 9 illustrates the use of four pump light sources and shows the gain bandwidth each pump source contributes to the overall gain bandwidth OG.

In an alternative embodiment the light source 10, 110, 210, 310, 410, 510, 610 is used to pump an erbium doped fibre to produce a “doped fibre amplifier”. The radiation from the light source is mixed with an input signal using a wavelength selective coupler. The mixed light is guided into a section of fibre with erbium ions in the core. This radiation from the light source excites the erbium ions to a higher-energy state. When photons of the optical signal, which are at a different wavelength from the pump light interact with the excited erbium atoms, the erbium atoms return to a lower-energy state simultaneously and the erbium atoms emit additional photons which are at the frequency/wavelength and same phase and direction as the optical signal being amplified.

It is envisaged that the components of the light source will be mounted in an optical module casing such as a “butterfly” package having an optical feedthrough such as an aperture for receiving an optical fibre and a plurality of electrical feedthroughs for providing electrical power and control to the components of the light source, it is also envisaged that a thermoelectric cooler will be provided for controlling the temperature of the components, it is also envisaged that an alternative method for cooling the pump different from the thermoelectric cooler could be used.

It can be appreciated that various changes may be made within the scope of the present invention, for example, the pump light source may comprise a plurality of gain devices, each resonator of which may be arranged such that each “lases” at different wavelengths or alternatively at substantially the same wavelength.

It will be recognised that as used herein, directional references such as “top”, “bottom”, “front”, “back”, “end”, “side”, “inner”, “outer”, “upper” and “lower” do not limit the respective features to such orientation, but merely serve to distinguish these features from one another. Furthermore it will be recognised the term “light” is not limited to the visible spectrum but includes electromagnetic radiation outside the spectrum visible to the human eye and includes inter alia infrared and ultraviolet radiation.

1. A tunable light source for use in an optical amplifier, comprising:
a gain device operable to provide light amplification, the gain device comprising a gain medium and a first reflective surface;
a wavelength selector which selects a part of the light from the gain device; and
an output coupler;
wherein the output coupler directs a portion of the light from the gain device towards the wavelength selector and another portion into an optical propagator for coupling to an optical amplifier, such that the gain device, output coupler and wavelength selector form a resonator.

2. The tunable light source according to claim 1, wherein the output coupler comprises a beam splitter.

3. The tunable light source according to claim 1, comprising two or more optical resonators, each comprising a gain device forming part of a respective resonator, wherein light output from each resonator is coupled together by a combiner and directed into the optical propagator.

4. The tunable light source according to claim 1, further comprising an actuator for changing wavelength of the light from the gain device.

5. The tunable light source according to claim 4, wherein the actuator rotates the wavelength selector about an axis perpendicular to the direction of travel of the light.

6. The tunable light source according to claim 4, wherein the actuator rotates a light redirector, preferably a mirror, which light redirector directs light from the gain device on to the wavelength selector wherein the light redirector is rotated about an axis perpendicular to the direction of travel of the light.

7. The tunable light source according to claim 4, wherein the actuator structurally deforms the wavelength selector to change the wavelength selected.

8. The tunable light source according to claim 7 wherein the structural deformation includes stretching, compressing and or bending the wavelength selector.

9. The tunable light source according claim 1, wherein the wavelength selector comprises a reflective diffraction grating.

10. A tunable light source for use in an optical amplifier, comprising:
two or more gain devices operable to provide light amplification, each gain device comprising a gain medium and a first reflective surface;
two or more actuatable wavelength selectors, each of which selects a part of the light from one of the gain devices; and
at least one output coupler, configured so that each gain device, output coupler and wavelength selector form a resonator, wherein the output coupler directs a portion of the light from each gain device into an optical propagator for coupling to an optical amplifier.

11. The tunable light source according to claim 10, wherein the at least one output coupler comprises at least one diffraction grating.

12. The tunable light source according to claim 10, wherein each resonator provides light at a different wavelength.

13. The tunable light source according to claim 10, wherein a light redirector directs light into the optical propagator.

14. A tunable light source for use in an optical amplifier, the light source comprising:
a gain device operable to provide light amplification, the gain device comprising a gain medium and a first and second end, the first end forming an end of an optical resonator;
a lens for collimating radiation emitted from the second end of the gain device and directing the radiation onto a beam splitter acting as an output coupler for allowing a portion of radiation to escape the optical resonator and for retaining a remaining portion within the optical resonator;
a reflective diffraction grating for wavelength selection of the radiation and forming a second end of the optical resonator; and
an actuator coupled to the reflective diffraction grating and operable to change the wavelength selection.

15. The tunable light source according to claim 14, wherein the beam splitter reflects the retained portion of the radiation in the optical resonator onto a light redirector, such as a mirror, which light redirector directs the radiation on to the reflective diffraction grating and wherein the actuator is coupled to the light redirector.

16. The tunable light source according to claim 14, further comprising:
a second gain device operable to provide light amplification, the second gain device comprising a second gain medium and a first and second end, the first end forming an end of an second optical resonator;
a second lens for collimating radiation emitted from the second end of the second gain device and directing the radiation onto a second beam splitter acting as a second output coupler for allowing a portion of radiation to escape the second optical resonator and for retaining a remaining portion within the second optical resonator;
a second reflective diffraction grating for wavelength selection of the radiation and forming a second end of the second optical resonator; and
a second actuator coupled to the second reflective diffraction grating and operable to change the wavelength selection of the second optical resonator.

17. The tunable light source according to claim 16, wherein the first and second beam splitters are offset from one another to prevent coupling radiation from one of the first or second optical resonators into the other of the first or second optical resonators.

18. The tunable light source according to claim 16, wherein the first and second beam splitters reflect the retained portion of the radiation in different directions, preferably opposite directions.

19. The tunable light source according to claim 16, wherein the first and second beam splitters reflect the retained portion of the radiation in the same direction.

20. The tunable light source according to claim 16 wherein the first beam splitter reflects the respective retained portion of the radiation onto a first light redirector, such as a mirror, which first light redirector directs the radiation in the first optical resonator onto the first reflective diffraction grating and wherein the second beam splitter reflects the respective retained portion of the radiation onto a second light redirector, such as a mirror, which second light redirector directs the radiation in the second optical resonator onto the second reflective diffraction grating and wherein the first and second actuators are coupled to the first or second light redirectors respectively.

21. The tunable light source according to claim 16 wherein the first beam splitter reflects the respective retained portion of the radiation onto a first light redirector, such as a mirror, which first light redirector directs the radiation in the first optical resonator onto the reflective diffraction grating and wherein the second beam splitter reflects the respective retained portion of the radiation onto a second light redirector, such as a mirror, which second light redirector directs the radiation in the second optical resonator onto the reflective diffraction grating such that the reflective diffraction grating forms part of both the first and second optical resonators and wherein the first and second actuators are coupled to the first or second light redirectors respectively.

22. A tunable light source for use in an optical amplifier, the light source comprising:
a gain device operable to provide light amplification, the gain device comprising a gain medium and a first and second end, the first end forming an end of an optical resonator;
a lens for collimating radiation emitted from the second end of the gain device and directing the radiation onto a reflective diffraction grating for wavelength selection of the radiation and acting as an output coupler allowing a portion of radiation to escape the optical resonator and retaining a remaining portion within the optical resonator;
a light redirector, such as a mirror, forming a second end of the optical resonator; an actuator coupled to the light redirector and operable to change the wavelength selection;
a second gain device operable to provide light amplification, the second gain device comprising a second gain medium and a first and second end, the first end forming an end of a second optical resonator;
a second lens for collimating radiation emitted from the second end of the second gain device and directing the radiation onto a second reflective diffraction grating for wavelength selection of the radiation and acting as a second output coupler for allowing a portion of radiation to escape the second optical resonator and for retaining a remaining portion within the second optical resonator; and
a second light redirector, such as a mirror, forming a second end of the second optical resonator and a second actuator coupled to the second light redirector and operable to change the wavelength selection of the second optical resonator wherein the reflective diffraction grating forms part of both the first and second optical resonators.

23. The tunable light source according to claim 22, further comprising a combiner for combining the radiation from the first and second optical resonators.

24. The tunable light source according to claim 22, wherein a lens directs light into an optical fibre.

25. The tunable light source according to claim 22, further comprising an isolator for preventing feedback when the light source is used in an optical amplifier.

26. The tunable light source for use in an optical amplifier according to claim 22, wherein the actuator comprises a Microelectromechanical system (MEMS).

27. An optical amplifier comprising the tunable light source according to claim 1.

28. A Raman amplifier system for amplification of an optical signal comprising the tunable light source of claim 1 as a pump light source.

29. The Raman amplifier according to claim 28, wherein two or more tunable lights sources are combined to increase the gain, or amplification of the optical signal, of the amplifier system.

30. The Raman amplifier system according to claim 28, wherein two or more tunable light sources are combined to increase the bandwidth over which the optical signal can be amplified.

31. An erbium doped fibre amplifier system for amplification of an optical signal comprising the tunable light source of claim 1 as a pump light source for excitation of erbium atoms in an optical fibre.
